(19) United States
(12) Patent Application Publication
(10) Pub. No.: US 2021/0086254 A1
(43) Pub. Date: Mar. 25, 2021

(54) Connecting Element

(71) Applicant: EJOT GmbH & Co. KG, Bad Berleburg (DE)

(72) Inventors: Eberhard CHRIST, Tambach-Dietharz (DE); Michael ACHENBACH, Breidenbach (DE)

(21) Appl. No.: 16/970,345

(22) PCT Filed: Feb. 14, 2019
(86) PCT No.: PCT/EP2019/053732

§ 371 Date: Aug. 14, 2020

(30) Foreign Application Priority Data
Feb. 14, 2018 (DE) 10 2018 103 326.5

(51) Int. Cl. B21H 3/02; F16B 25/00; B23K 9/04; F16B 25/10

(52) U.S. Cl. CPC B21H 3/027; F16B 25/0094; F16B 19/14; F16B 25/103; B23K 9/048

(57) ABSTRACT

The invention relates to a connecting element (10, 30) for connecting at least two components that are positioned one on top of the other, comprising a shaft (14, 34) and a head (12, 32), which is provided with a drive (38), the shaft (14, 34) being formed from a base material and ending at the exposed shaft end thereof that is opposite the head (12, 32). The invention is characterised in that a tip (16, 40) made of plating material is applied to the exposed shaft end, which plating material is different from the base material.

The invention relates to a connecting element of the type specified in the preamble of claim 1, and to a method for its production as specified in claim 11.

It is generally known to produce self-tapping screws in a two-steel design in order to provide high corrosion resistance of the load-bearing area and/or of the head, and at the same time to obtain a high degree of hardness of the cutting threads.

A screw of this type is disclosed in DE 20 2006 000 606 U1, for example.

The disadvantage of producing a screw in this way is that it requires two bolt parts made of solid material to be connected. The connection of the two bolt parts results in a center offset which must be compensated for by a separate rolling operation.

It is the object of the invention to create a self-tapping screw having a low susceptibility to corrosion that can be used for cutting threads into components with higher strength, and to provide a method for its production.

This object is accomplished by the characterizing features of claim 1 in conjunction with the features of its preamble.

The subclaims relate to advantageous further developments of the invention.

In a known manner, a connecting element for connecting at least two components that are positioned the one on top of the other comprises a shaft and a head which is provided with a drive.

The shaft is formed from a base material and ends at the exposed shaft end that is opposite the head.

According to the invention, the exposed shaft end made of base material is followed by a tip region made of a plating material which was applied in particular by weld cladding. The tip region is applied to the front end of the shaft.

In weld cladding, volume is built up exclusively by the introduction of a welding consumable.

This allows different material properties to be advantageously obtained in one connecting element. For example, the plating material can be a material that is harder than the base material, or a hardenable material. This enables the penetration of components having a hardness greater than that of the base material.

Advantageous properties of the base material, especially with regard to corrosion resistance, can thus be exploited without having to take into account any hardness requirements necessary for the retaining properties.

For example, the base material can be a rust-proof stainless steel, or a non-ferrous metal, or a non-ferrous metal alloy.

Preferably, the plating material is a martensitic hardenable steel.

However, the plating material can also be a mixture of materials. Such a material mixture may for example consist of stainless steel, tungsten carbide and other components with specific properties such as those known under the brand name of Stellite™, for example.

Preferably, the plating material can form a tip in the tip region. Such tip can be produced in particular using a rolling or a pinching process, or other kinds of manufacturing processes.

Mechanical finishing of the weld-cladded tip region allows the production of drill tips or flow-drilling tips for screws or other connecting elements, for example friction welding connecting elements or rivets or nails.

Besides the tip, the connecting element may preferably exhibit additional functional regions between the tip and the head. This can be, for example, a screw thread, which is especially designed as a self-tapping thread.

According to the invention, in this type of thread-forming screw, in particular hole-forming and self-tapping screw, the self-tapping portion of the screw thread can also have a thread made of a weld-cladded material.

As an alternative, the connecting element can be a friction welding connecting element.

According to the invention, the tip of the connecting element does not necessarily have to be of an acute-angled design. It can also take a rounded or obtuse-angled form.

In another aspect of the invention, the invention relates to a method for manufacturing a connecting element of the type described above.

According to the invention, at least the exposed end of a shaft, in particular a bare shaft, made of a base material is coated with a plating material so as to allow a tip to be formed from the plating material.

The plating material is applied to the front end of the shaft.

Preferably, further processing of the plating material in the tip region can be used to produce a tip of the connecting element there.

Preferably, the plating material can be applied using a weld cladding method, in particular laser cladding, laser powder cladding, arc welding or plasma-transferred arc welding, or other kinds of generative methods.

According to a preferred embodiment, the free shaft end made of base material can be of a cylindrical shape. This provides an as large as possible contact surface for connecting the shaft of base material to the deposited plating material.

The tip region can extend from a front tapered end of the connecting element to a full shaft diameter, or it can extend only partially in the front region.

In particular, the front end can be of a point-shaped, a ball-shaped or a flattened design.

After having been weld-cladded to the exposed shaft end, the tip region is preferably mechanically deformed or machined. This allows difference tip geometries to be provided as required.

In addition to the tip, other functional structures can be deposited on the shaft.

The functional structure can preferably be a self-tapping screw thread. For this purpose, the plating material can be deposited in particular in the tapping area of the screw thread.

This allows a nut thread to be produced in a component having a hardness that is greater than the hardness of the base material of the connecting element which in this case is designed as a self-tapping and/or a hole-forming screw.

The layer thickness of the plating material is preferably at least 3% of the shaft diameter.

Furthermore, the invention relates to a method for the production of a screw of the aforementioned type that has a drive and a screw shaft with a thread. The thread has a load bearing portion and a self-tapping portion. The screw shaft is made of a base material.

The main body is first press-molded from the base material, and in the area of the self-tapping region of the thread, the body is then coated with a plating material which is weld-cladded onto the base material. The thread in the self-tapping region is formed by the plating material.

According to a first embodiment, the thread can be applied directly to the base material. This is achieved in particular by welding a weld bead around the shaft in a helical form as is common for screws.

In this way, welding on the thread can directly produce a self-tapping thread. This makes it possible to produce threads having in particular an obtuse flank angle or rounded thread flanks.

This can be implemented particularly well for coarse threads, such as those required for concrete screws. Concrete screws are defined as follows.

The thread formed on the screw shaft exclusively by weld-cladding has a rough structure on its surface, with the result that the thread flank has abrasive properties.

The thread can preferably be produced by press-molding the screw blank in such a way that it has a smaller radial extent in the region to be coated than in the region not to be coated.

The plating material is welded onto the base material, after which the main body of base material has a coating of weld-cladded plating material. In particular, the coating is applied in such a way that the screw shaft has the same outside diameter throughout. The screw blank coated with the plating material is then rolled in such a manner that the weld-cladded region and parts of the base material are formed into a thread in this process.

In this way, self-tapping threads can be produced to have a defined flank angle by subsequently forming the welded-on material into such a shape.

In this way, a self-tapping screw can be produced which has a high toughness even in the region of the cutting thread, also has good corrosion properties in the load-bearing region of the thread and the head, and yet has hard thread flanks, allowing it to be screwed into components of great hardness in a self-tapping manner.

According to another preferred embodiment, the plating material can be applied to the base material in the form of beads or by coating it on the surface, in particular on the entire surface, in an enveloping manner.

The plating material can be deposited in such a way that the plating material is only welded on in the self-tapping region. This results in a two-steel screw, for example, which has a self-tapping thread made of hardened steel in the front part of its self-tapping region and a thread made of stainless steel, in particular of corrosion- and acid-resistant steel in its load-bearing region.

This produces improved retaining properties with very good self-tapping characteristics.

A screw can thus be provided that has a thread which has been rolled both in its weld-cladded self-tapping region and in its retaining region. As an alternative, a screw can also be provided having a thread that has been rolled in the retaining region and had only been formed by the mechanically untreated weld-cladded plating material in the self-tapping region.

Prior to the weld-cladding of the plating material, grooves can preferably be made in the base material of the screw shaft in which the weld-cladding is then carried out.

Weld cladding can be carried out by laser cladding, arc welding or plasma powder welding.

Additional advantages, features and possible applications of the present invention may be gathered from the description which follows in which reference is made to the embodiments illustrated in the drawings.

In the drawings,

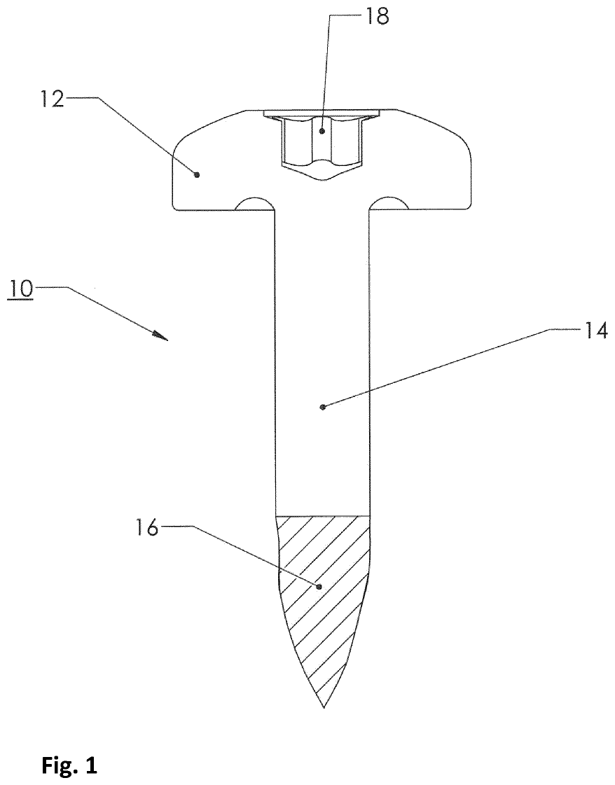

FIG. 1 is a schematic sectional view of a friction pin according to the invention;

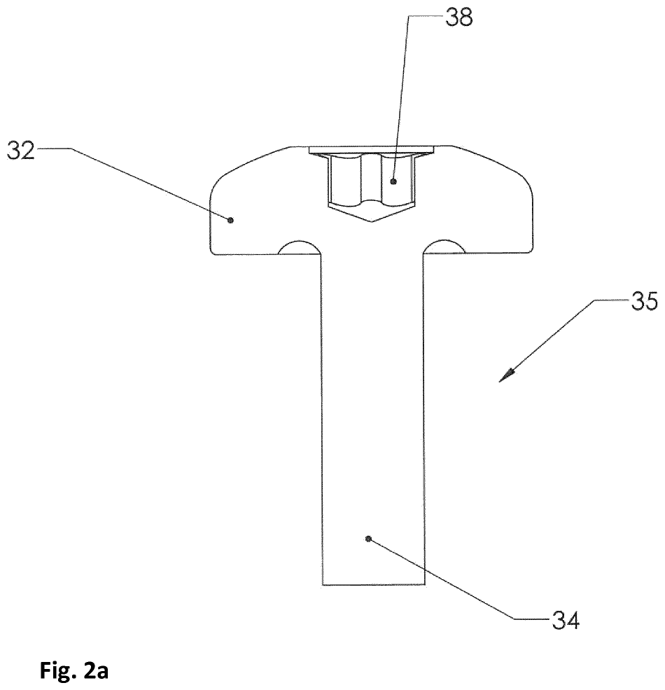

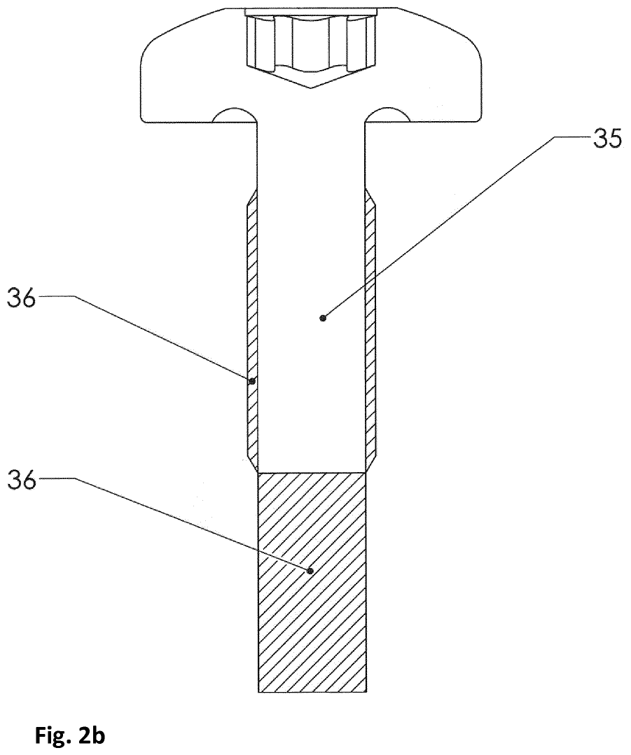

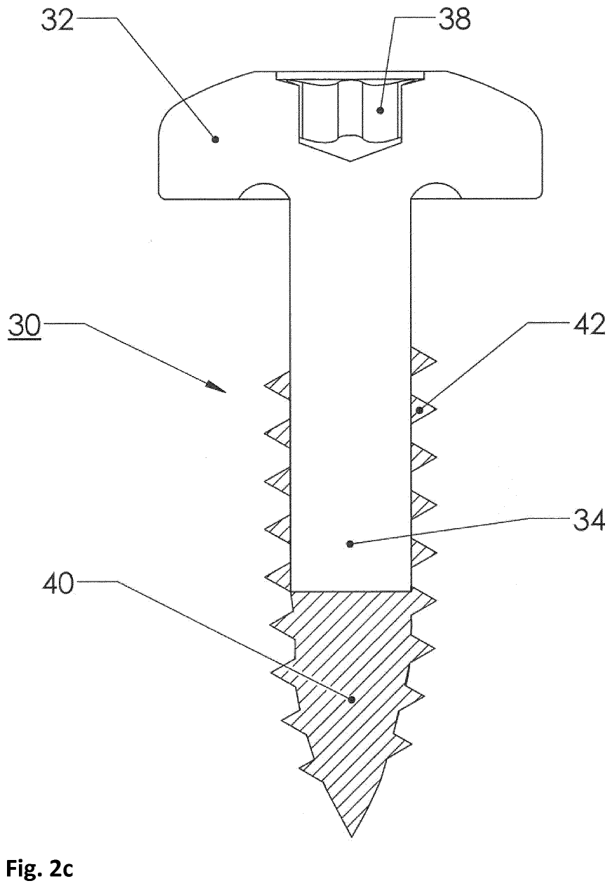

FIGS. 2a to 2c are a schematic sectional view each of a self-tapping screw according to the invention, and

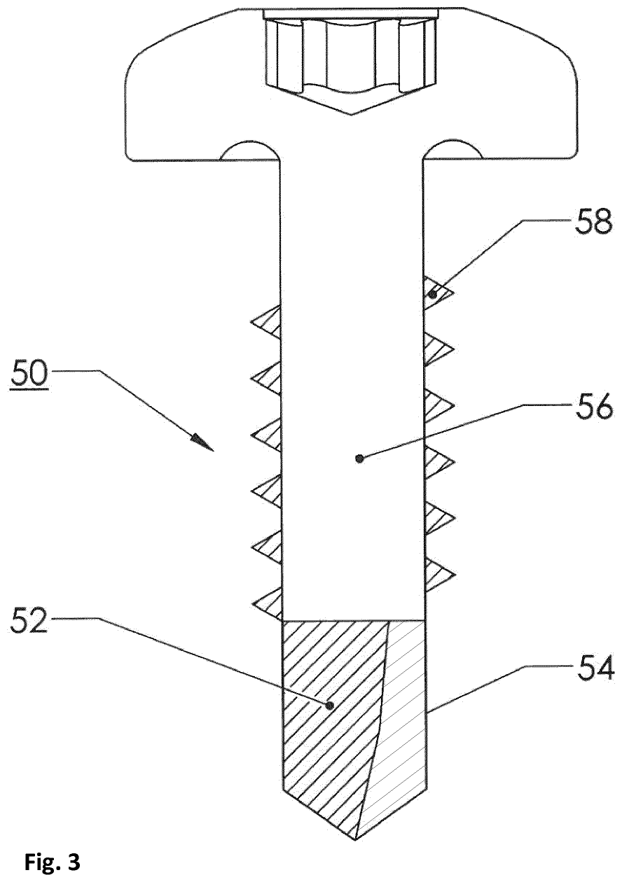

FIG. 3 is a schematic sectional view of a self-tapping and hole-drilling screw according to the invention.

The view of FIG. 1 shows a connecting element 10 for penetrating panel materials, comprising a head 12 and a shaft 14. The head 12 has a drive. The shaft 14 has a point formed thereon by weld cladding, in particular by laser cladding. The weld cladded tip is made of a harder material than the shaft 14 and also than the head 12, which are preferably both made of the same first material. As a result, when screwed in under rotation and with pressure, the connecting element 10 shown is capable of penetrating component layers that are harder than the first material. Nevertheless, after penetration of the component layers to be connected, a friction-welded joint can be produced between the component layers and the specially adapted connecting element.

The shaft 14 and the head 12 can be ideally designed with regard to corrosion resistance, whereas the tip can only be designed with hardness in mind.

FIGS. 2a to 2c are schematic sectional views each of the production of a self-tapping screw 30 having a hole-forming tip 40, with the tip 40 and the thread 42 being formed of a plating material different from the base material of the shaft 34 and the head 32 of the screw.

The view of FIG. 2a is the base element 35 of the bolt comprising the head 32 and the shaft 34, both made of the base material. A drive 38 made in the head 32 is used to transfer a rotary movement to the connecting element 30. The base element 35 produced in this way is coated with a plating material in an additional step, as is shown in FIG. 2b.

The plating material is a harder material than the base material. In this case, the base material is stainless steel, whereas the plating material is tempered steel. The latter can be additionally hardened. Another hardening step can involve the selective heating of the tip and the thread, for example.

The plating material is preferably deposited by means of powder deposition welding.

As seen in FIG. 2b, the plating material 36 is applied both in the region of the thread 42 and in the region of the tip.

Next, the connecting element is subjected to a rolling step in which both the tip and the thread are formed.

The finished rolled screw 30 is shown in FIG. 2c.

In this way, a connecting element can exhibit a hole-forming tip as well as a self-tapping thread which are both made of a material which is harder than that used for the shaft. The material properties of the individual regions can thus complement each other.

FIG. 3 is a schematic view of another embodiment of a screw 50 according to the invention. The screw 50 has a drill tip 52 which cuts a hole in a component.

It is manufactured substantially in the same manner as described with reference to FIG. 2a, 2b. The drill tip 52 is produced by weld cladding a plating material 54 onto the tip region of the free end of the base element 56 made of the base material.

The plating material 54 in the tip region of the screw 50 is not rolled, but molded using cold forming so as to produce a drill tip 52. This allows a hard drill tip 52 to be produced which is reliably connected to a base element of the shaft.

As is further seen in FIG. 3, at least part of the thread 58 can also be formed from the plating material 54. The plating material 54 can be applied in a single step together with the weld cladding of the plating material in the tip region. The final formation of the thread is achieved by the rolling process following the production of the drill tip 52.

1. Connecting element (10, 30, 50) for connecting at least two components that are positioned the one on top of the other, comprising a shaft (14, 34, 56) and a head (12, 32), which is provided with a drive (38), the shaft (14, 34, 36) being formed from a base material and ending at its exposed end that is opposite the head (12, 32), and a tip region (16, 40, 52) made of a plating material (36) is applied to the exposed shaft end, which plating material (36) is different from the base material.

2. Connecting element according to claim 1, wherein the plating material (36) is a material that is hardenable or harder than the base material.

3. Connecting element according to claim 1, wherein the tip region is formed as a tip (16, 40, 52).

4. Connecting element according to claim 1, wherein the base material is an acid-resistant stainless steel, or a non-ferrous metal alloy.

5. Connecting element according to claim 1, wherein the plating material at the tip is formed into its final tip shape by rolling or pressing.

6. Connecting element according to claim 1, wherein the plating material at the tip is formed into its final tip shape by machining.

7. Connecting element according to claim 1, wherein the connecting element (30) is a self-tapping screw.

8. Connecting element according to claim 6, wherein at least in at least part of its tapping region, the self-tapping screw (30, 50) exhibits a thread (42, 58) made of plating material.

9. Connecting element according to claim 1, wherein the connecting element is a friction welding element.

10. Connecting element according to claim 1, wherein the tip (16, 40) is of a rounded, an acute-angled or an obtuse-angled design.

11. Method for producing a connecting element (10, 30) comprising forming a shaft (14, 34, 56) and a head (12, 32), which is provided with a drive (38), the shaft (14, 34, 36) being formed from a base material and ending at its exposed end that is opposite the head (12, 32), and a tip region (16, 40, 52) made of a plating material (36) is applied to the exposed shaft end, which plating material (36) is different from the base material, and at least at the exposed end of the shaft, a plating material is weld-cladded onto the base material of the shaft (14, 34, 56) so as to allow the tip (16, 40) of the connecting element to be formed from the plating material.

12. Method according to claim 11, wherein the exposed shaft end made of base material is cylindrical and has a circular end surface.

13. Method according to claim 11, wherein after the tip region has been weld-cladded onto the exposed shaft end, the tip is mechanically formed, for example by means of a forming or a machining process.

14. Method according to claim 12, wherein in addition to the tip, further functional structures are weld-cladded onto the shaft.

15. Method according to claim 14, wherein the functional structure is a self-tapping thread.

16. Method according to claim 14, wherein the thread is produced by rolling a thread on the screw shaft after the plating material has been deposited on the screw shaft.

17. Method according to claim 14, wherein the thread is produced by applying the plating material in a helical pattern on the shaft in such a manner that the thread is completed once the plating material has been deposited.

18. Method according to claim 14, wherein the plating material is deposited in the form of beads or over the entire surface.

19. Method according to claim 16, wherein the weld beads extend parallel to the screw axis or in spirals around the screw shaft.

20. Method according to claim 14, wherein before weld-cladding the plating material onto the shaft, grooves are made in the base material of the screw shaft in which the weld-cladding is then performed.

21. Method according to claim 14, wherein the weld-cladding is performed by means of laser cladding, arc welding or plasma powder deposition welding.
